(19) United States
(12) Patent Application Publication
(10) Pub. No.: US 2026/0200493 A1
(43) Pub. Date: Jul. 16, 2026

(54) SUM OF SQUARES PIPELINED FLOATING-POINT CALCULATIONS

(71) Applicant: Mobileye Vision Technologies Ltd., Jerusalem (IL)

(72) Inventors: Gad Tuchman, Kiryat Bialik (IL); Mario Shalabi, Haifa (IL); Cristina S. Anderson, Hillsboro, OR (US)

(21) Appl. No.: 19/134,912

(22) PCT Filed: Dec. 7, 2023
(86) PCT No.: PCT/US2023/082861

§ 371 Date: Jun. 2, 2025

Related U.S. Application Data
(60) Provisional application No. 63/430,859, filed on Dec. 7, 2022.

(51) Int. Cl. B60W 60/00; B60W 50/14; G06T 7/70

(52) U.S. Cl. CPC B60W 60/001; B60W 50/14; G06T 7/70; B60W 2420/40; B60W 2720/10; B60W 2720/24; G06T 2207/30252

(57) ABSTRACT

Distance calculations for autonomous vehicle (AV) or advanced driver assistance system (ADAS) navigation may include calculating a distance between two points within an image captured by a vehicle camera. To calculate distance in ADAS and AV systems, the vectors and other values may be represented as floating-point (FP) values. The use of FP values may provide improved performance of these calculations in ADAS, AV systems, and other systems that seek to reduce or minimize computation speed. When the input values are represented as FP values, the distance may be calculated as a square root of a sum of squares of the two FP values. Improved systems and methods are provided for floating-point calculation related to a square root, such as for determining distance calculations.

### PRIORITY

This application claims the benefit of priority to U.S. Provisional Patent Application Ser. No. 63/430,859, filed Dec. 7, 2022, which is incorporated by reference herein in its entirety.

### BACKGROUND

Physical distance calculations may be used in various navigation scenarios, such as driving by an autonomous vehicle (AV) or using an advanced driver assistance system (ADAS). Both AV and ADAS implementations use radar, lidar, cameras and other sensors combined with object classifiers and trained networks, which are designed to detect specific objects in an environment of a vehicle navigating a road. Object classifiers and trained networks are designed to detect predefined objects and are used within ADAS and AV systems to control the vehicle or alert a driver based on the detected object type, location, direction, distance, speed, and other detected object characteristics. As ADAS and AV systems progress towards fully autonomous operation, it would be beneficial to provide improved floating-point calculations for distance determination and other calculations in resource-constrained environments.

### SUMMARY

Distance calculations for AV or ADAS navigation and for other purposes may include calculating a distance between two points. In an example, the distance calculation may be based on perpendicular input vectors, such as a latitude value and a longitude value. The distance may be calculated as the distance between an endpoint of the first vector and endpoint of the second vector. To implement distance and other calculations in ADAS and AV systems, the vectors and other values may be represented as floating-point (FP) values. The use of FP values may provide improved performance of these calculations in ADAS, AV systems, and other systems that seek to reduce or minimize computation speed. In various examples, distance calculations may be used to identify a stationary object size or distance, a street sign type or distance, a nearby vehicle distance or motion, or other navigation inputs. The navigation inputs may be used to provide notifications or control inputs for autonomous navigation, autonomous driving, or driver assist technology features, such as steering control, automatic braking, or other notifications or control inputs.

When the input values are represented as FP values, the distance may be calculated as a square root of a sum of squares of the two FP values. This FP distance calculation may be complex and may be a bottleneck of distance or other calculations, especially for resource-constrained environments such as ADAS and AV systems. Additionally, these FP values may be stored in memory units and may be communicated among various memory and computational units while being limited to a certain length based on memory or communication restraints. In order to maintain the certain length, a rounding operation is applied during a multiplication of FP values, however each rounding operation may reduce the accuracy of the product of the multiplication or other intermediate calculations. Improved systems and methods may be used to provide improved floating-point calculations related to a square root, such as for determining distance calculations. In an example, the square root calculations are executed without requiring rounding operations to improve the accuracy of intermediate calculations.

It would be appreciated that while throughout the present disclosure reference is made to ADAS or AV system, embodiments of the improved floating-point calculations related to a square root in the present disclosure are not necessarily limited in this regard. As used in present disclosure, calculations (e.g., determinations) made in parallel refer to parallel computing of multiple calculations without requiring calculations to be performed sequentially. In an example, a calculation of a first squared value and a second squared value may be performed in parallel, as the inputs and outputs to each calculation do not depend upon each other, thus the calculations may be executed simultaneously in parallel. This parallel processing may provide improved efficiency by calculating multiple values simultaneously, thereby reducing the processing time to the sum of the time required for both calculations to the maximum time required for any one of the parallel calculations.

There may be provided a method for floating-point calculation related to a square root, such as for determining distance calculations. The method may include receiving, by a first processing circuit, a first FP value and a second FP value; determining a scaling factor; calculating, in parallel, a square of the first FP value and a square of the second FP value; wherein the calculating is executed without requiring rounding and by enhanced range floating-point non-rounding multipliers of a second processing circuit; summing, by a third processing circuit, the square of the first FP value and the second FP value to provide a non-rounded sum; applying a downscaling by the scaling factor and rounding operations on the non-rounded sum to provide a downscaled and rounded sum; calculating a square root of the downscaled rounded sum; and upscaling, by a square root of the scaling factor, the square root of the downscaled rounded sum to provide an output value. The first processing circuit may include a processor or hardware accelerator. The second processing circuit may include a hardware accelerator. The third processing circuit may include an enhanced range adder of the hardware accelerator.

There may be provided a hardware accelerator for floating-point calculation related to a square root, such as for determining distance calculations. The hardware accelerator may include one or more inputs that are configured to receive a first FP value and a second FP value; a scaling factor unit configured to determine a scaling factor; enhanced range floating-point non-rounding multipliers that are configured to calculate, in parallel and without requiring rounding, a square of the first FP value and a square of the second FP value; an enhanced range adder of the hardware accelerator that is configured to add a square of the first FP value and the second FP value to provide a non-rounded sum; a scaler and rounder that is configured to apply a downscaling by the scaling factor and rounding operations on the non-rounded sum to provide a downscaled and rounded sum; a square root calculator that is configured to calculate a square root of the downscaled rounded sum; and an output scaler that is configured to upscale, by a square root of the scaling factor, the square root of the downscaled rounded sum to provide an output value.

There may be provided a method for floating-point calculation related to a square root, such as for determining distance calculations. The method may include receiving, by a hardware accelerator, a first floating-point (FP) value and a second FP value; determining a scaling factor; downscaling the first FP value by the scaling factor to provide a first downscaled FP value; downscaling the second FP value by the scaling factor to provide a second downscaled FP value; calculating, in parallel, a square of the first downscaled FP value and a square of the second downscaled FP value; wherein the calculating is executed without requiring rounding and by enhanced range floating-point non-rounding multipliers of a hardware accelerator; summing, by an enhanced range adder of the hardware accelerator, the square of the first FP value and the second FP value to provide a non-rounded sum; rounding the non-rounding sum to provide a rounded sum; calculating a square root of the rounded sum; and upscaling, by the scaling factor, the square root of the rounded sum to provide an output value.

There may be provided a method for floating-point calculation related to a square root, such as for determining distance calculations. The method may include receiving, by a hardware accelerator, a first floating-point (FP) value and a second FP value; determining a scaling factor; downscaling the first FP value by the scaling factor to provide a first downscaled FP value; downscaling the second FP value by the scaling factor to provide a second downscaled FP value; calculating, in parallel, a square of the first downscaled FP value and a square of the second downscaled FP value; wherein the calculating is executed without requiring rounding and by enhanced range floating-point non-rounding multipliers of a hardware accelerator; summing, by an enhanced range adder of the hardware accelerator, the square of the first FP value and the second FP value to provide a non-rounded sum; rounding the non-rounding sum to provide a rounded sum; calculating a square root of the rounded sum; and upscaling, by the scaling factor, the square root of the rounded sum to provide an output value.

There may be provided a hardware accelerator for floating-point calculation related to a square root, such as for determining distance calculations. The hardware accelerator may include one or more inputs that are configured to receive a first floating-point (FP) value and a second FP value; a scaling factor unit that is configured to determine a scaling factor; a first input scaler that is configured to downscale the first FP value by the scaling factor to provide a first downscaled FP value; a second input scaler that is configured to downscale the second FP value by the scaling factor to provide a second downscaled FP value; enhanced range floating-point non-rounding multipliers that are configured to calculate, in parallel and without requiring rounding, a square of the first downscaled FP value and a square of the second downscaled FP value; an enhanced range adder of the hardware accelerator that is configured to add the square of the first FP value and the second FP value to provide a non-rounded sum; a rounder that is configured to round the non-rounding sum to provide a rounded sum; a square root calculator that is configured to calculate a square root of the rounded sum; and an output scaler that is configured to upscale, by the scaling factor, the square root of the rounded sum to provide an output value.

There are provided systems and methods as illustrated in the claims and the specification. Any combination of any subject matter of any claim may be provided. Any combination of any method or method step disclosed in any figure or in the specification may be provided. Any combination of any unit, device, or component disclosed in any figure or in the specification may be provided. Non-limiting examples of such units include a gather unit, an image processor, and the like.

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples.

### BRIEF DESCRIPTION OF THE DRAWINGS

The subject matter regarded as the invention is particularly pointed out and distinctly claimed in the concluding portion of the specification. The subject matter, however, both as to organization and method of operation, together with objects, features, and advantages thereof, may best be understood by reference to the following detailed description when read with the accompanying drawings in which:

FIG. 1 is a block diagram representation of a system consistent with the disclosed embodiments;

FIG. 2A is a diagrammatic side view representation of an exemplary vehicle including a system consistent with the disclosed embodiments;

FIG. 2B is a diagrammatic top view representation of the vehicle and system shown in FIG. 2A consistent with the disclosed embodiments;

FIG. 2C is a diagrammatic top view representation of another embodiment of a vehicle including a system consistent with the disclosed embodiments;

FIG. 2D is a diagrammatic top view representation of yet another embodiment of a vehicle including a system consistent with the disclosed embodiments;

FIG. 2E is a diagrammatic representation of exemplary vehicle control systems consistent with the disclosed embodiments;

FIG. 3 is a diagrammatic representation of an interior of a vehicle including a rearview mirror and a user interface for a vehicle imaging system consistent with the disclosed embodiments;

FIG. 4 illustrates an example of an image acquired by a vehicle camera;

FIG. 5 illustrates an example of a format of a FP value and a format of another FP entity;

FIG. 6 illustrates an example of a hardware accelerator its environment and a timing diagram;

FIG. 7 illustrates an example of at least a part of a hardware accelerator;

FIG. 8 illustrates another example of at least a part of a hardware accelerator;

FIG. 9 illustrates another example of at least a part of a hardware accelerator;

FIG. 10 illustrates another example of at least a part of a hardware accelerator;

FIG. 11 illustrates another example of at least a part of a hardware accelerator;

FIG. 12 illustrates another example of at least a part of a hardware accelerator;

FIG. 13 illustrates an example of a method;

FIG. 14 illustrates another example of a method; and

FIG. 15 illustrates another example of a method.

### DETAILED DESCRIPTION OF THE DRAWINGS

In the following detailed description, numerous specific details are set forth in order to provide a thorough understanding of the subject matter. However, it will be understood by those skilled in the art that the present subject matter may be practiced without these specific details. In other instances, well-known methods, procedures, and components have not been described in detail so as not to obscure the present subject matter. The subject matter, both as to organization and method of operation, together with objects, features, and advantages thereof, may best be understood by reference to the following detailed description when read with the accompanying drawings.

Disclosed embodiments provide systems and methods that can be used as part of or in combination with autonomous navigation, autonomous driving, or driver assist technology features. As opposed to fully autonomous driving, driver assist technology may refer to any suitable technology to assist drivers in the navigation or control of their vehicles. Examples of driver assist technology include Forward Collision Warning (FCW), Lane Departure Warning (LDW), Traffic Sign Recognition (TSR), Driver Monitoring System (DMS) and other driver assist technologies. In various embodiments, the system may include one, two, or more cameras mountable in a vehicle and an associated processor that monitors the environment of the vehicle. In further embodiments, additional types of sensors can be mounted in the vehicle and can be used in the autonomous navigation or driver assist system, such as one or more Lidar systems or one or more Radar systems. In some examples of the presently disclosed subject matter, the system may provide techniques for processing images of an environment in front of or surrounding a vehicle navigating a road for training a computer network (e.g., a neural network) or deep learning algorithms to estimate a future path of a vehicle based on images. In yet further examples of the presently disclosed subject matter, the system may provide techniques for processing images of an environment in front of or surrounding a vehicle navigating a road using a trained network to estimate a future path of the vehicle.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present subject matter may be implemented using electronic components and circuits known to those skilled in the art, details will not be explained in any greater extent than that considered necessary as illustrated above, for the understanding and appreciation of the underlying concepts of the present subject matter and in order not to obfuscate or distract from the teachings of the present subject matter.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by the memory device and should be applied mutatis mutandis to a non-transitory computer readable medium that stores instructions that may be executed by the memory device. For example, there may be provided a method or method steps executed by the image processor described in the specification or claims, such as a graphical processing unit (GPU) or another image processor.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, or any part of the specification or any claims may be provided. Particularly, any combination of any claimed feature may be provided.

Before discussing examples in detail, such as examples of features of the processing images of an environment in advance of a vehicle navigating a road for training a computer network or deep learning algorithms to estimate a future path of a vehicle based on images or feature of the processing of images of an environment in advance of a vehicle navigating a road using a trained network to estimate a future path of the vehicle, there is provided a description of various possible implementations and configurations of a vehicle mountable system that can be used for carrying out and implementing the methods according to examples of the presently disclosed subject matter. In some embodiments, various examples of the system can be mounted in a vehicle, and can be operated while the vehicle is in motion. In some embodiments, the system can implement the methods according to examples of the presently disclosed subject matter.

However, it would be appreciated that embodiments of the present disclosure are not limited to scenarios where a suspected upright object indication is caused by a high-grade road. The suspected upright object indication can be associated with various other circumstances, and can result from other types of image data or from non-image data (e.g., data that is not image-based, data that is not exclusively image-based). In various examples, the non-image data may include ranging data or navigation data that may be used for distance calculations or other calculations, such as radar ranging data, lidar ranging data, odometer distance data, global positioning system (GPS) data, accelerometer data, or other non-image data.

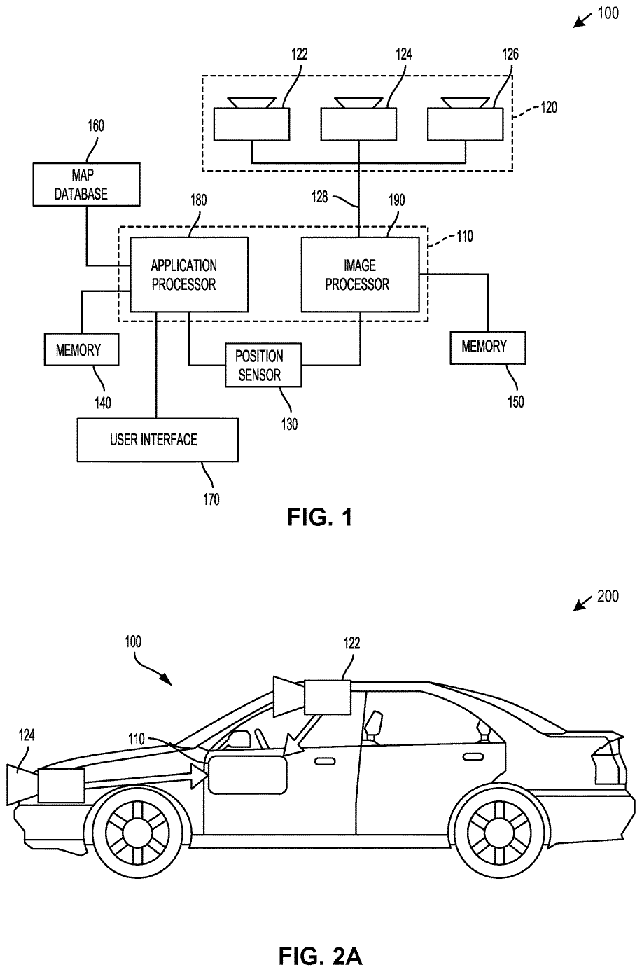

FIG. 1, to which reference is now made, is a block diagram representation of a vehicle system 100 consistent with the disclosed embodiments. Vehicle system 100 can include various components depending on the requirements of a particular implementation. In some examples, vehicle system 100 can include a processing unit 110, an image acquisition system 120, and one or more memory units 140, 150. Processing unit 110 can include one or more processing devices. In some embodiments, processing unit 110 can include an application processor 180, an image processor 190, or any other suitable processing device. Similarly, image acquisition system 120 can include any number of image acquisition devices and components depending on the requirements of a particular application. In some embodiments, image acquisition system 120 can include one or more image capture devices (e.g., cameras), such as image capture device 122, image capture device 124, and image capture device 126. In some embodiments, vehicle system 100 can also include a data interface 128 communicatively connecting processing unit 110 to image acquisition system 120. For example, data interface 128 can include any wired or wireless link or links for transmitting image data acquired by image acquisition system 120 to processing unit 110.

Both application processor 180 and image processor 190 can include various types of processing devices. For example, either or both of application processor 180 and image processor 190 can include a hardware accelerator, which may provide improved performance for multiple parallel FP calculations. Performing multiple calculations in parallel may provide improvements in processing times over solutions that perform calculations sequentially. In various examples, either or both of application processor 180 and image processor 190 can include one or more microprocessors, preprocessors (such as image preprocessors), graphics processors, central processing units (CPUs), support circuits, digital signal processors, integrated circuits, memory, or any other types of devices suitable for running applications and for image processing and analysis. In various embodiments, application processor 180 or image processor 190 can include any type of single or multi-core processor, mobile device microcontroller, central processing unit, or other type of processor. Various processing devices can be used, for example including processors available from manufacturers (e.g., Intel®, AMD®, etc.), and can include various architectures (e.g., x86 processor, ARM®, etc.).

In some embodiments, application processor 180 or image processor 190 can include any of the EyeQ series of processor chips available from Mobileye®. These processor designs each include multiple processing units with local memory and instruction sets. Such processors may include video inputs for receiving image data from multiple image sensors, and may also include video out capabilities. In one example, the EyeQ2® uses 90 nm-micron technology operating at 332 Mhz. The EyeQ2® architecture has two floating point, hyper-thread 32-bit RISC CPUs (MIPS32® 34K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP®, the DMA, the second MIPS34K CPU, the multi-channel DMA, and the other peripherals. The five VCEs, three VMP® and the MIPS34K CPU can perform intensive vision computations required by multi-function bundle applications. In another example, the EyeQ3®, which is a third-generation processor and is six times more powerful that the EyeQ2®, may be used in the disclosed examples. In yet another example, the EyeQ4®, the fourth-generation processor, may be used in the disclosed examples.

While FIG. 1 depicts two separate processing devices included in processing unit 110, more or fewer processing devices can be used. For example, in some examples, a single processing device may be used to accomplish the tasks of application processor 180 and image processor 190. In other embodiments, these tasks can be performed by more than two processing devices.

Processing unit 110 can include various types of devices. For example, processing unit 110 may include various devices, such as a controller, an image preprocessor, a central processing unit (CPU), support circuits, digital signal processors, integrated circuits, memory, or any other types of devices for image processing and analysis. The image preprocessor can include a video processor for capturing, digitizing, and processing the imagery from the image sensors. The CPU can include any number of microcontrollers or microprocessors. The support circuits can be any number of circuits generally well-known in the art, including cache, power supply, clock, and input-output circuits. The memory can store software that, when executed by the processor, controls the operation of the system. The memory can include databases and image processing software, including a trained system, such as a neural network, for example. The memory can include any number of random-access memories (RAM), read only memories (ROM), flash memories, disk drives, optical storage, removable storage, and other types of storage. In one instance, the memory can be separate from the processing unit 110. In another instance, the memory can be integrated into the processing unit 110.

Each memory 140, 150 can include software instructions that when executed by a processor (e.g., application processor 180 or image processor 190), can control operation of various aspects of vehicle system 100. These memory units can include various databases and image processing software. The memory units can include random access memory, read only memory, flash memory, disk drives, optical storage, tape storage, removable storage, or any other types of storage. In some examples, memory units 140, 150 can be separate from the application processor 180 or image processor 190. In other embodiments, these memory units can be integrated into application processor 180 or image processor 190.

In some embodiments, the system can include a position sensor 130. The position sensor 130 can include any type of device suitable for determining a location associated with at least one component of vehicle system 100. In some embodiments, position sensor 130 can include a global positioning system (GPS) receiver. Such receivers can determine a user position and velocity by processing signals broadcasted by GPS satellites. Position information from position sensor 130 can be made available to application processor 180 or image processor 190.

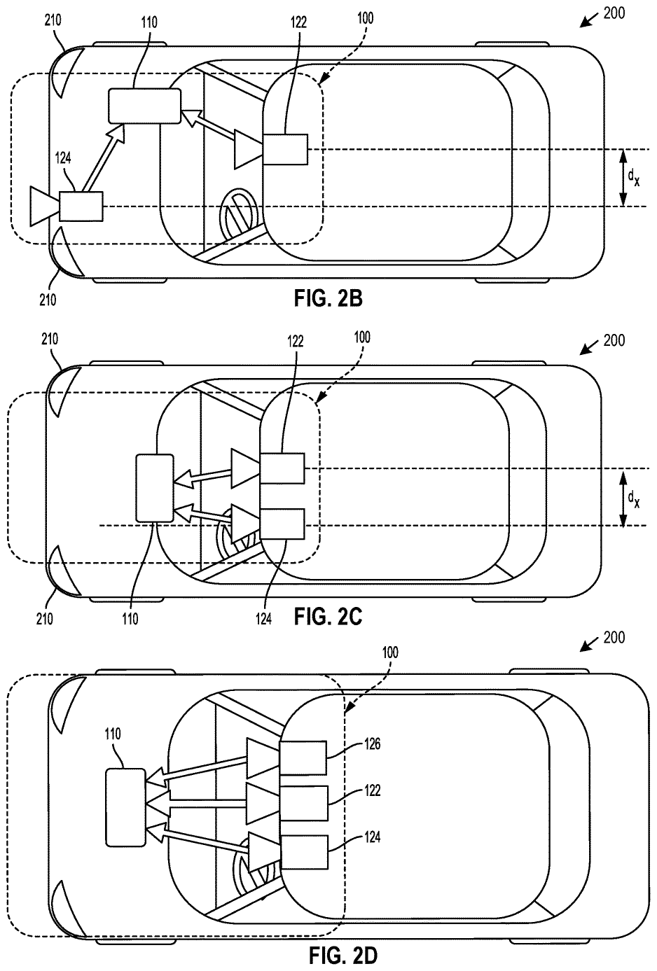

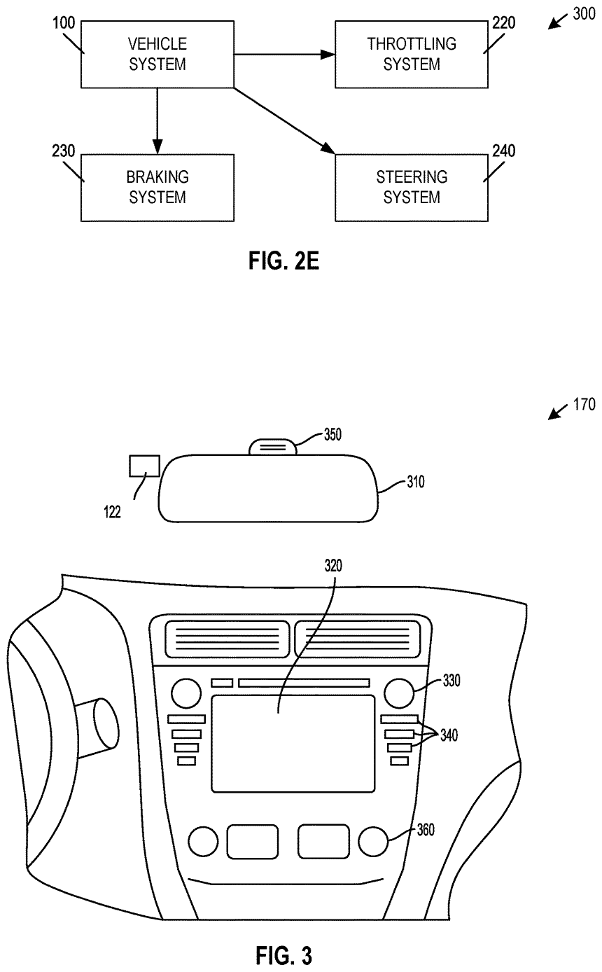

In some embodiments, the vehicle system 100 can be operatively connectible to various systems, devices, and units onboard a vehicle in which the vehicle system 100 can be mounted, and through any suitable interfaces (e.g., a communication bus) the vehicle system 100 can communicate with the vehicle's systems. Examples of vehicle systems with which the vehicle system 100 can cooperate include a throttling system, a braking system, and a steering system (e.g., throttling system 220, braking system 230, and steering system 240 of FIG. 2E).

In some embodiments, the vehicle system 100 can include a user interface 170. User interface 170 can include any device suitable for providing information to or for receiving inputs from one or more users of vehicle system 100, for example including a touchscreen, microphone, keyboard, pointer devices, track wheels, cameras, knobs, buttons, etc. Information can be provided by the vehicle system 100, through the user interface 170, to the user.

In some embodiments, the vehicle system 100 can include a map database 160. The map database 160 can include any type of database for storing digital map data. In some examples, map database 160 can include data relating to a position, in a reference coordinate system, of various items, including roads, water features, geographic features, points of interest, etc. Map database 160 can store not only the locations of such items, but also descriptors relating to those items, for example including names and other information associated with any of the stored features. For example, the database may include locations and types of known obstacles, information about a topography of a road or a grade of certain points along a road, etc. In some embodiments, map database 160 can be physically located with other components of vehicle system 100. Alternatively, or additionally, map database 160 or a portion thereof can be located remotely with respect to other components of vehicle system 100 (e.g., processing unit 110). In such remote embodiments, information from map database 160 can be downloaded over a wired or wireless data connection to a network (e.g., over a cellular network or the Internet, etc.).

Image capture devices 122, 124, and 126 can each include any type of device suitable for capturing at least one image from an environment. Moreover, any number of image capture devices can be used to acquire images for input to the image processor. Some examples of the presently disclosed subject matter can include or can be implemented with only a single-image capture device, while other examples can include or can be implemented with two, three, four, or more image capture devices. Image capture devices 122, 124, and 126 will be further described with reference to FIGS. 2B-2E, below.

It would be appreciated that the vehicle system 100 can include or can be operatively associated with other types of sensors, for example including an acoustic sensor, a radio frequency (RF) sensor (e.g., radar transceiver), a LIDAR sensor, or other sensors. Such sensors can be used independently of or in cooperation with the image acquisition system 120. For example, data from a radar system (not shown) can be used for validating the processed information that is received from processing images acquired by the image acquisition system 120, such as to filter certain false positives resulting from processing images acquired by the image acquisition system 120. Data from a radar system can also be combined with or otherwise compliment the image data from the image acquisition system 120, or be combined with some processed variation or derivative of the image data from the image acquisition system 120.

Vehicle system 100, or various components thereof, can be incorporated into various different platforms. In some embodiments, vehicle system 100 may be included on a vehicle 200, as shown in FIG. 2A. For example, vehicle 200 can be equipped with a processing unit 110 and any of the other components of vehicle system 100, as described above relative to FIG. 1. While in some embodiments, vehicle 200 can be equipped with only a single-image capture device (e.g., camera), in other embodiments multiple image capture devices can be used, such as those discussed in connection with FIGS. 2B-2E, multiple image capture devices can be used. For example, either of image capture devices 122 or 124 of vehicle 200, as shown in FIG. 2A, can be part of an ADAS (Advanced Driver Assistance Systems) imaging set.

The image capture devices included on vehicle 200 as part of the image acquisition system 120 can be positioned at any suitable location. In some embodiments, as shown in FIGS. 2A-2E and 3, image capture device 122 can be located in the vicinity of the rearview mirror (e.g., mirror 310 of FIG. 3). This position may provide a line of sight similar to that of the driver of vehicle 200, which can aid in determining what is and is not visible to the driver.

Other locations for the image capture devices of image acquisition system 120 can also be used. For example, image capture device 124 can be located on or in a bumper of vehicle 200. Such a location can be especially suitable for image capture devices having a wide field of view. The line of sight of bumper-located image capture devices can be different from that of the driver. The image capture devices (e.g., image capture devices 122, 124, and 126) can also be located in other locations. For example, the image capture devices may be located on or in one or both of the side mirrors of vehicle 200, on the roof of vehicle 200, on the hood of vehicle 200, on the trunk of vehicle 200, on the sides of vehicle 200, mounted on, positioned behind, or positioned in front of any of the windows of vehicle 200, and mounted in or near vehicle lights on the front or back of vehicle 200, or in other locations. The image capture unit 120, or an image capture device that is one of a plurality of image capture devices that are used in an image capture unit 120, can have a field-of-view (FOV) that is different than the FOV of a driver of a vehicle, and not always see the same objects. In one example, the FOV of the image acquisition system 120 can extend beyond the FOV of a typical driver and can thus image objects which are outside the FOV of the driver. In yet another example, the FOV of the image acquisition system 120 is some portion of the FOV of the driver. In some embodiments, the FOV of the image acquisition system 120 corresponding to a sector which covers an area of a road in advance of a vehicle and possibly also surroundings of the road.

In addition to image capture devices, vehicle 200 can be include various other components of vehicle system 100. For example, processing unit 110 may be included on vehicle 200 either integrated with or separate from an engine control unit (ECU) of the vehicle 200. Vehicle 200 may also be equipped with a position sensor 130, such as a GPS receiver and may also include a map database 160 and memory units 140 and 150.

FIG. 2A is a diagrammatic side view representation of a vehicle imaging system according to examples of the presently disclosed subject matter. FIG. 2B is a diagrammatic top view illustration of the example shown in FIG. 2A. As illustrated in FIG. 2B, the disclosed examples can include a vehicle system 100 within a vehicle 200. The vehicle system 100 may include a first image capture device 122 positioned in the vicinity of the rearview mirror or near the driver of vehicle 200, a second image capture device 124 positioned on or in a bumper region (e.g., one of bumper regions 210) of vehicle 200, and a processing unit 110.

As illustrated in FIG. 2C, image capture devices 122 and 124 may both be positioned in the vicinity of the rearview mirror or near the driver of vehicle 200. Additionally, while two image capture devices 122 and 124 are shown in FIGS. 2B and 2C, it should be understood that other embodiments may include more than two image capture devices. For example, in the embodiment shown in FIG. 2D, vehicle system 100 includes a first image capture device 122, a second image capture device 124, and a third image capture device 126.

As shown in FIG. 2D, image capture devices 122, 124, and 126 may be positioned in the vicinity of the rearview mirror or near the driver seat of vehicle 200. The disclosed examples are not limited to any particular number and configuration of the image capture devices, and the image capture devices may be positioned in any appropriate location within or on vehicle 200. It is also to be understood that disclosed embodiments are not limited to a particular type of vehicle 200 and may be applicable to all types of vehicles including automobiles, trucks, trailers, motorcycles, bicycles, self-balancing transport devices and other types of vehicles.

The first image capture device 122 can include any suitable type of image capture device. Image capture device 122 can include an optical axis. In one instance, the image capture device 122 can include an Aptina M9V024 WVGA sensor with a global shutter. In another example, a rolling shutter sensor can be used. Image acquisition system 120, and any image capture device which is implemented as part of the image acquisition system 120, can have any desired image resolution. For example, image capture device 122 can provide a resolution of 1280×960 pixels and can include a rolling shutter. As used herein, a pixel may include a picture element obtained by a camera, and may be a picture element processed by an image processing device (e.g., CPU, GPU).

Image acquisition system 120, and any image capture device that is implemented as part of the image acquisition system 120, can include various optical elements. In some embodiments, one or more lenses can be included, such as to provide a desired focal length and field of view for the image acquisition system 120. These lenses may be used for any image capture device that is implemented as part of the image acquisition system 120. In some examples, an image capture device that is implemented as part of the image acquisition system 120 can include or can be associated with any optical elements, such as a 6 mm lens or a 12 mm lens. In some examples, image capture device 122 can be configured to capture images having a desired and known FOV.

The first image capture device 122 may have a scan rate associated with acquisition of each of the first series of image scan lines. The scan rate may refer to a rate at which an image sensor can acquire image data associated with each pixel included in a particular scan line.

FIG. 2E is a diagrammatic representation of vehicle control systems 300, according to examples of the presently disclosed subject matter. As indicated in FIG. 2E, vehicle 200 can include throttling system 220, braking system 230, and steering system 240. Vehicle system 100 can provide inputs (e.g., control signals) to one or more of throttling system 220, braking system 230, and steering system 240 over one or more data links (e.g., any wired or wireless link or links for transmitting data). For example, based on analysis of images acquired by image capture devices 122, 124, or 126, vehicle system 100 can provide control signals to one or more of throttling system 220, braking system 230, and steering system 240 to navigate vehicle 200 (e.g., by causing an acceleration, a turn, a lane shift, etc.). Further, vehicle system 100 can receive inputs from one or more of throttling system 220, braking system 230, and steering system 240 indicating operating conditions of vehicle 200 (e.g., speed, whether vehicle 200 is braking or turning, etc.).

FIG. 3 is a diagrammatic representation of a user interface 170 consistent with the disclosed embodiments. As shown in FIG. 3, vehicle 200 may also include a user interface 170 for interacting with a driver or a passenger of vehicle 200. The user interface 170 may include one or more sensors positioned near a rear-view mirror 310 or a console display 320. For example, user interface 170 in a vehicle application may include a touch screen display 320, knobs 330, buttons 340, and a microphone 350. A driver or passenger of vehicle 200 may also use handles (e.g., turn signal handles located on or near the steering column of vehicle 200), buttons (e.g., located on the steering wheel of vehicle 200), and the like, to interact with vehicle system 100. In some embodiments, a microphone 350 may be positioned adjacent to a rearview mirror 310. Similarly, in some embodiments, image capture device 122 may be located near rearview mirror 310. In some embodiments, user interface 170 may also include one or more speakers 360 (e.g., speakers of a vehicle audio system). For example, vehicle system 100 may provide various notifications (e.g., alerts) via speakers 360.

As will be appreciated by a person skilled in the art having the benefit of this disclosure, numerous variations or modifications may be made to the foregoing disclosed embodiments. For example, not all components are essential for the operation of vehicle system 100. Further, any component may be located in any appropriate part of vehicle system 100 and the components may be rearranged into a variety of configurations while providing the functionality of the disclosed embodiments. Therefore, the foregoing configurations are examples and, regardless of the configurations discussed above, vehicle system 100 can provide a wide range of functionality to analyze the surroundings of vehicle 200 and, in response to this analysis, navigate or otherwise control or operate vehicle 200. Navigation, control, or operation of vehicle 200 may include enabling or disabling (directly or via intermediary controllers, such as the controllers mentioned above) various features, components, devices, modes, systems, or subsystems associated with vehicle 200. Navigation, control, or operation may alternately or additionally include interaction with a user, driver, passenger, passerby, or other vehicle or user, which may be located inside or outside vehicle 200, for example by providing visual, audio, haptic, or other sensory alerts or indications.

As discussed below in further detail and consistent with various disclosed embodiments, vehicle system 100 may provide a variety of features related to autonomous driving, semi-autonomous driving or driver assist technology. For example, vehicle system 100 may analyze image data, position data (e.g., GPS location information), map data, speed data, or data from sensors included in vehicle 200. Vehicle system 100 may collect the data for analysis from, for example, image acquisition system 120, position sensor 130, and other sensors. Further, vehicle system 100 may analyze the collected data to determine whether or not vehicle 200 should take a certain action, and then automatically take the determined action without human intervention. It would be appreciated that in some cases, the actions taken automatically by the vehicle are under human supervision, and the ability of the human to intervene adjust abort or override the machine action is enabled under certain circumstances or at all times. For example, when vehicle 200 navigates without human intervention, vehicle system 100 may automatically control the braking, acceleration, or steering of vehicle 200 (e.g., by sending control signals to one or more of throttling system 220, braking system 230, and steering system 240). Further, vehicle system 100 may analyze the collected data and issue warnings, indications, recommendations, alerts, or instructions to a driver, passenger, user, or other person inside or outside of the vehicle (or to other vehicles) based on the analysis of the collected data. Additional details regarding the various embodiments that are provided by vehicle system 100 are provided below.

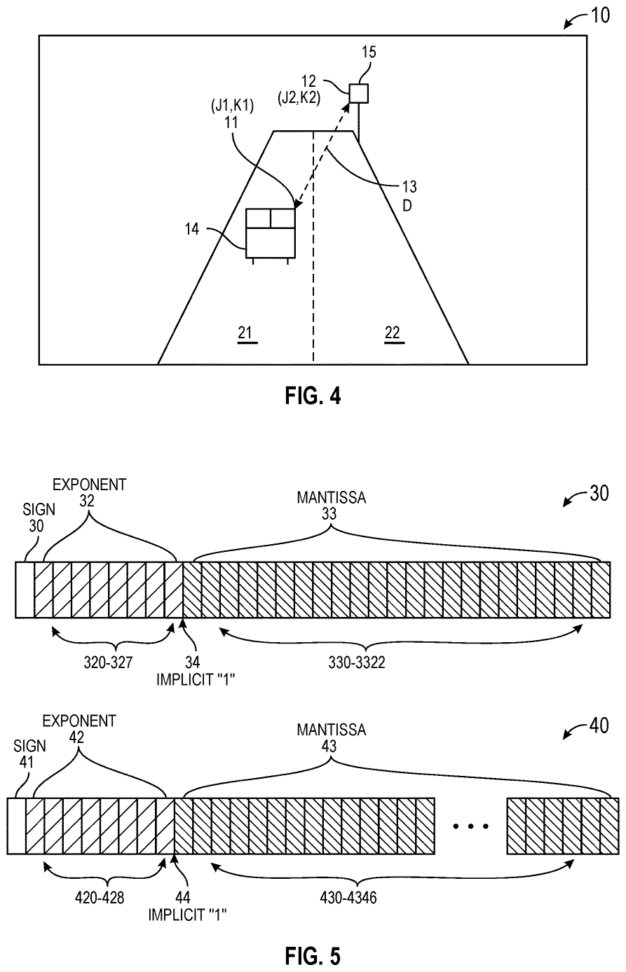

FIG. 4 illustrates an example of image 10 that was acquired by a camera of a vehicle and illustrates first lane 21, second lane 22, incoming vehicle 14, and sign road 15. Assuming that there is a need to calculate the distance (D13) between a right upper edge (represented by first pixel 11 having coordinates J1 and K1) of incoming vehicle 14 and a left lower edge (represented by second pixel 12 having coordinates J2 and K2) of road sign 15.

The distance between two or more locations identified by a captured image may be calculated using a sum of squares. Methods, non-transitory computer readable media, hardware accelerators, and other systems described herein provide improved speed and accuracy for distance calculations and other calculations related to sums of squares. In an example, a hardware accelerator may include one or more integrated circuit, may be a part of an integrated circuit, may differ from a general-purpose processor, may be at least a part of an application specific integrated circuit (ASIC) or may be at least a part of a field programmable gate array (FPGA), and the like.

While various figures illustrate a sum of squares of two values, it should be noted that the sum may include of more than two squares. Any reference to a sum of squares may be applied to a sum of more than two squares. For example, distance between two pixels in 3-D space may be calculated as a sum of (a) a square of a first coordinate difference between the two pixels, (b) a square of a second coordinate difference between the two pixels, and (c) a square of a third coordinate difference between the two pixels, and so forth for higher dimensionality spaces (4D, 5D, etc.). It should be noted that any reference to a square of a value may be applied mutatis mutandis to a multiplication of one value by another value. In the latter case the square root of the sum of two values may not provide distance information. An example of the improved sum of squares calculation, such as may be used to provide an improved a distance calculation, is shown and described with respect to FIG. 5.

FIG. 5 illustrates an example of a format of a floating-point (FP) value 30 inputted to the hardware accelerator, and a format of another FP entity 40. The other FP entity 40 may include a product, a sum of products, a square of a value, a sum of squares of values, and the like within a hardware accelerator.

A FP value (e.g., an input value to the process) may consist of a sign bit (“sign” 31), a first plurality (N1) of exponent bits (in FIG. 4 N1 equals eight) 32(0)-32(7), a second plurality (N2) of mantissa bits (in FIG. 4 N2 equals twenty three) 33(0)-33(22), and an implicit mantissa most significant bit (“implicit “1”) 34.

The other FP entity may consist of a sign bit (“sign” 31), a third plurality (N3) of exponents bits (in FIG. 4 N3 equals nine) 42(0)-42(8), a fourth plurality (N4) of mantissa bits (in FIG. 4 N4 equals forty seven) 43(0)-43(47) and an implicit mantissa most significant bit (“implicit “1”) 34. Alternatively, the other FP entity may have (N3+1) exponent bits. N3 may equals N1 plus one. N4 may equal one plus twice N2.

Any one of N1, N2, N3 and N4 may have any other value that the values illustrated in FIG. 5.

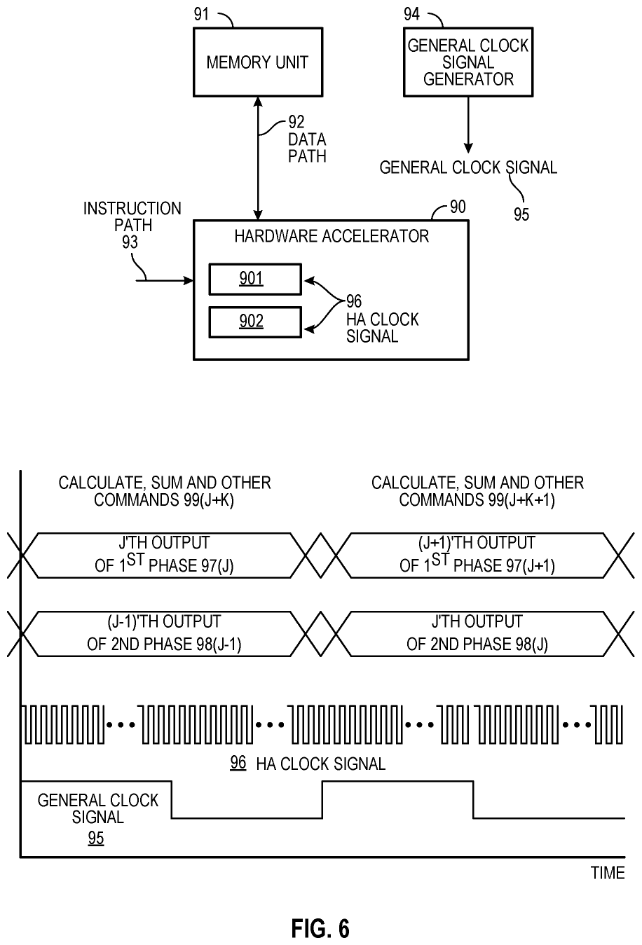

FIG. 6 illustrates an example of a hardware accelerator 90, its environment, and also illustrates a timing diagram. The environment may include a memory unit 91, a data path 92, a command source (not shown) to send instructions over instruction path 93, and a general clock signal generator 94 for generating general clock signal 95 that may be used to control the communication over the instruction path 95 and the data path 92. In an example, the hardware accelerator 90 represents a hardware accelerator core for processing instructions, the memory unit 91 represents a hardware accelerator memory, and the combination of the hardware accelerator core and memory unit 91 may be within a hardware accelerator system. In an example, the memory unit 91 includes one or more register files. In another example, the memory unit 91 is separate from one or more register files, and the memory unit 91 and register files are connected via an interface of a certain size that may require or benefit from rounding, such as the interface with width of thirty-two bits shown in FIG. 5.

The source of instructions may be an application processor (e.g., application processor 180 of FIG. 1), an image processor (e.g., image processor 190 of FIG. 1), or another processor. The hardware accelerator (HA) 90 may operate using a HA clock signal 96 that is faster than the general clock signal (e.g., 2×, 10×, 100× more cycles per second than the general clock signal frequency), allowing the HA to complete multiple operations per cycle of the general clock signal. The hardware accelerator 90 may calculate in parallel, multiple products of FP values without requiring rounding. The hardware accelerator 90 may perform additional operations (for example, downscaling, adding the multiple products, or rounding) in a first hardware accelerator (HA) sub-unit 90(1). The hardware accelerator 90 may perform further operations such as calculating square root or upscaling, in second HA sub-unit 90(2).

The first HA sub-unit and the second HA sub-unit may work in a pipelined manner. In pipelined operation, a set of data processing steps or data processing devices may be connected in series, where the output of a previous data processing step or device is used as an input to a subsequent data processing step or device. One or more of the data processing steps or devices may include multiple operations performed in parallel or in a time-sliced manner. A buffer or other memory may be used for temporary storage of the output of one data processing step or device before providing that output to the subsequent data processing step or device.

In an example pipelined operation, during a J′th cycle of the general clock signal, the first HA sub-unit 90(1) outputs a J′th output of a 1^{st} phase 97(J), the second HA sub-unit 90(2) outputs a (J−1)′th output of a 2^{nd} phase 98(J−1), the HA receives the (J+K)th calculate, sum and other commands (command per phase). K is indicative of the latency of the pipeline. During a (J+1)′th cycle of the general clock signal, the first HA sub-unit 90(1) outputs a (J+1)′th output of a 1^{st} phase 97(J+1), the second HA sub-unit 90(2) outputs a J′th output of a 2^{nd} phase 98(J), the HA receives the (J+K+1)th calculate, sum, and other commands (command per phase).

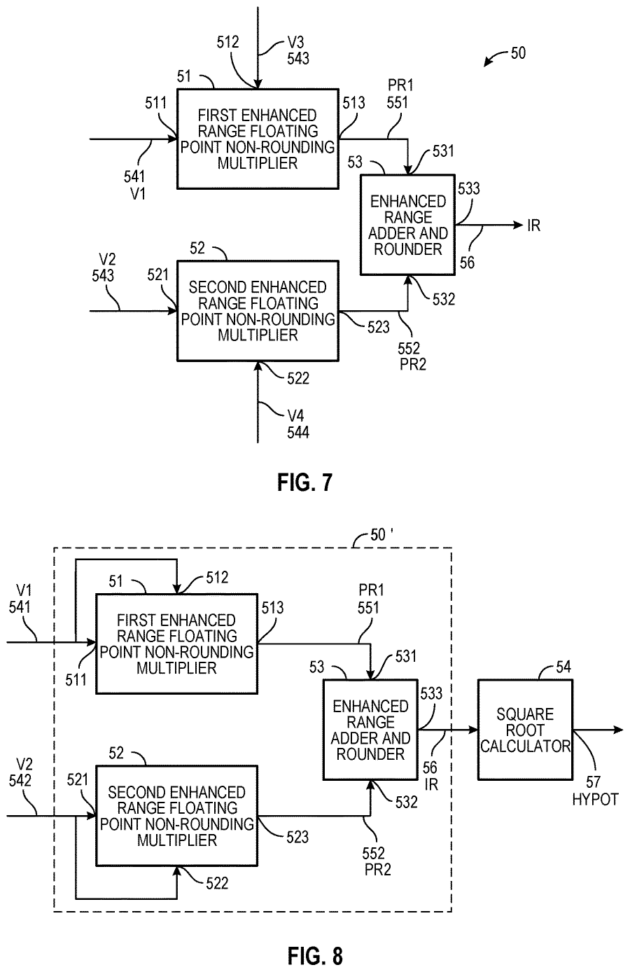

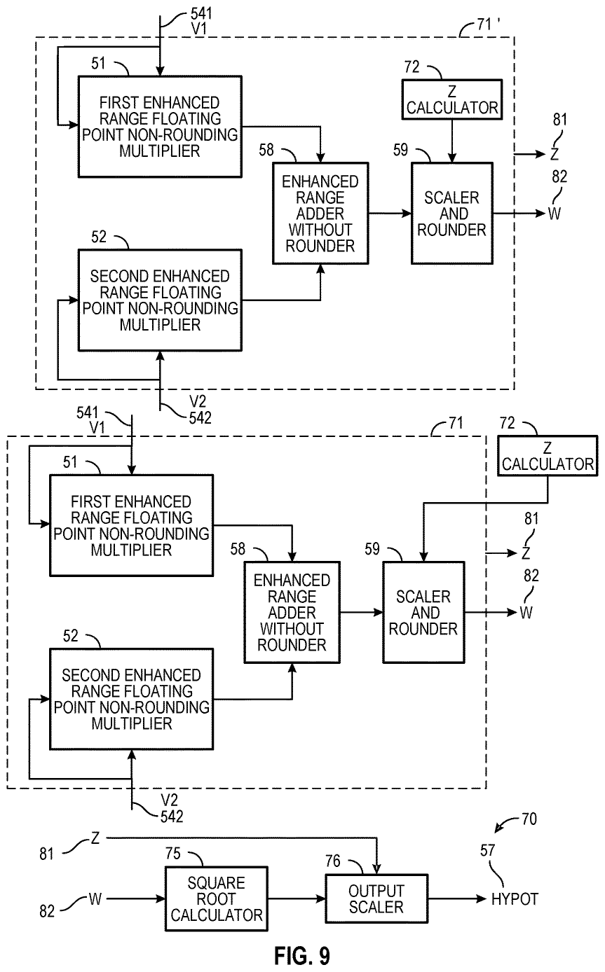

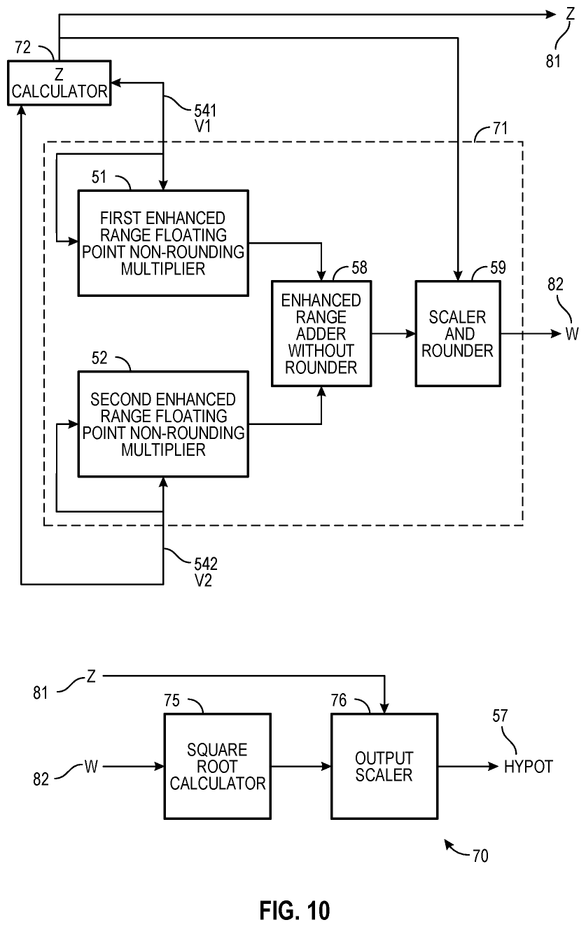

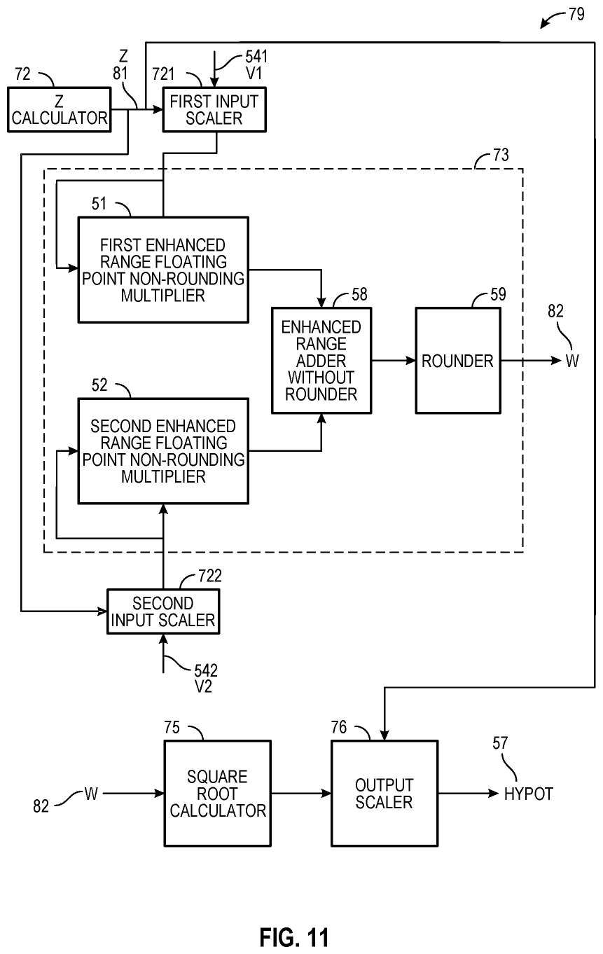

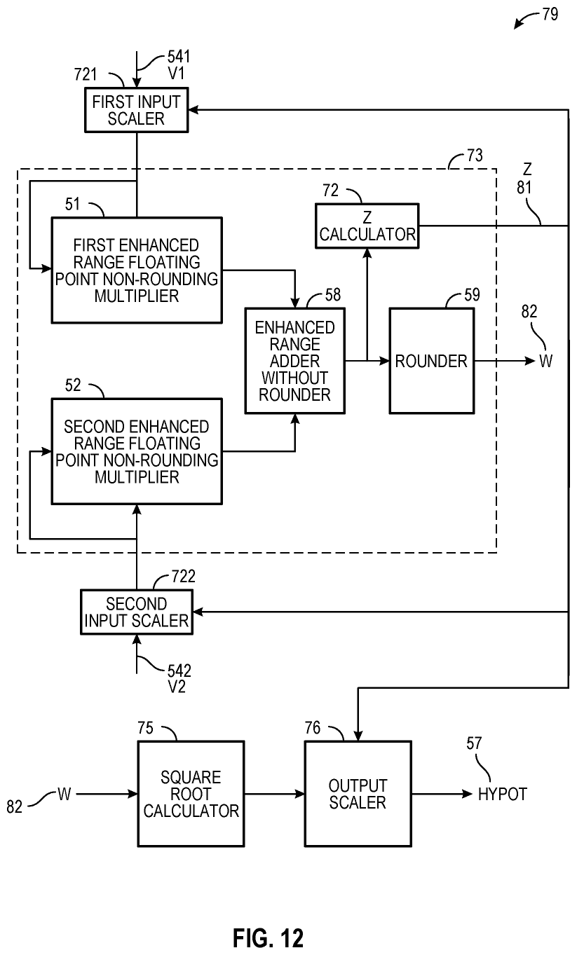

FIGS. 7-12 illustrate examples of at least parts of the hardware accelerator 90. For example, the first HA sub-unit 90(1) of FIG. 6 may be or may include any one of a first HA part 50 of FIG. 7, a first HA part 50′ of FIG. 8, a first HA part 71 of FIG. 9, a first HA part 71′ of FIG. 9 or 10, a first HA part 71′ of FIG. 9 or 10, or first HA part 73 of FIG. 11 or 12. For example, the second HA sub-unit 90(2) of FIG. 6 may be or may include any one of square root calculator 54 of FIG. 8, square root calculator 75 and scaler 76 of FIG. 9 or 10 or 11 or 12. It should be noted that the hardware accelerator may include the first HA sub-unit without the second HA sub-unit.

FIG. 7 illustrates an example of first HA part 50. The first HA part 50 includes first enhanced range floating-point non-rounding multiplier 51, second enhanced range floating-point non-rounding multiplier 52 and enhanced range adder and rounder 53.

As used herein, “enhanced range” indicates a full range or substantially full range (e.g., one less exponent bit) range for accurately representing the product of multiplication of a sum of multiplications before rounding.

First enhanced range floating-point non-rounding multiplier 51 has first input 51(1) for receiving first FP value V1 54(1), a second input 51(2) for receiving third FP value V3 54(3) and an output 51(3) for outputting a first non-rounded product Pr 55(1).

Second enhanced range floating-point non-rounding multiplier 52 has first input 52(1) for receiving second FP value V2 54(2), a second input 53(2) for receiving fourth FP value V4 54(4) and an output 52(3) for outputting a second non-rounded product Pr 55(2).

Enhanced range adder and rounder 53 may perform the enhanced range addition and then a rounding operation, to fit the output to the certain size used over the paths or the memory unit of FIG. 6.

The enhanced range adder and rounder 53 has a first input 53(1) for receiving the first non-rounded product Pr 55(1), a second input 53(2) for receiving the second non-rounded product Pr 55(2), and an output for outputting an adder output signal Ir 56.

The output adder signal may be fed to a square root unit—but may be fed to other units—for example to another processor, to an image processor, to an application processor, to a memory unit, and the like.

FIG. 8 illustrates an example of first HA part 50′ and a square root calculator 54.

The first HA part 50′ has the same components as the first HA part 50 of FIG. 1, but instead of receiving four FP values, it receives two FP values, and calculates squares of each of the two FP values.

The first enhanced range floating-point non-rounding multiplier 51 calculates a square (without requiring rounding) of first value 54(1).

The second enhanced range floating-point non-rounding multiplier 52 calculates a square (without requiring rounding) of second value 54(2).

In addition, the adder output signal Ir 56 is fed to a square root calculator 54 that output a square root of sums of a square of the first FP value V1 54(1) and a square of the second FP value V2 54(2).

### Expanding a Dynamic Range of the HA Using Scaling

The calculation (especially without requiring rounding) of the squares of the FP values and especially the summation of the squares (especially without requiring rounding) may lead to an overflow, which limits the dynamic range of the hardware accelerator.

In order to increase the dynamic range, a downscaling may be applied, and is followed (after various calculations) by a corresponding upscaling.

The downscaling may be applied during various steps, for example it may be applied on the input FP values, or on a non-rounded sum of squares of the input FP values.

The downscaling and upscaling may be based on the following representation of the HYPOT function:

$$\sqrt{{x}^{2} + {y}^{2}} = \sqrt{( {( {2}^{+ z} * {2}^{- z} * x )}^{2} + {( ( {2}^{+ z} * {2}^{- z} * y ) )}^{2} )} = \sqrt{( {2}^{+ 2 z} * {( {2}^{- z} * x )}^{2} + {2}^{+ 2 z} * {( {2}^{- z} * y )}^{2} )} = {2}^{+ z} \sqrt{( {( {2}^{- z} * x )}^{2} + {( {2}^{- z} * y )}^{2} )} = {2}^{+ z} \sqrt{{2}^{- 2 z} ( {x}^{2} + {y}^{2} )}$$

The calculation of the HYPOT may be broken to two phases, during the first phase an intermediate value w and a value z related to the scaling factor may be calculated.

The downscaling of the input FP values may be executed as follows:
1) Scaling a first FP value to provide a first scaled FP value (scaled_V1): scaled_V1=V1*2^{-Z}).
2) Scaling a second FP value to provide a second scaled FP value (scaled_V2): scaled_V2=V2*2^{-Z}).
3) Calculating a non-rounded sum w′ of squares of scaled_V1 and scaled_V2: w′=((scaled_V1)²+(scaled_V2)².

This may be followed by a second phase of calculating a square root of w′ and up-scaling the square root of w′ by 2^{Z}.

Alternatively, the input FP values may not be scaled, but the non-rounded sum of the squares of V1 and V2 may be down-sampled (multiplied by 2^{-2Z}) to provide a rounded sum, whereas the rounded sum is fed to a square root calculator that has its output be up-scaled by 2^{Z}.

The value of z may be calculated in various manners, for example as a function of any fields of any of the input values, any square of input value, any non-rounded sum, and the like.

FIGS. 9-12 illustrate various examples of first HA parts and second HA parts. They differ from each other by at least one out of the manner in which the z-factor is calculated or when the downscaling takes place.

FIG. 9 illustrates a first example (first HA part 71) in which the z-calculator belongs to the first HA part 71 and the rounding is applied on the non-rounded sum (by scaler and rounder 59 that followed enhanced range adder without rounder 58).

FIG. 9 also illustrated a second example (first HA part 71′) in which the z-calculator does not belong to the first HA part 71, and the rounding is applied on the non-rounded sum (by scaler and rounder 59 that followed enhanced range adder without rounder 58).

Values z and w are sent to square root calculator 75 and output scaler 76 (that performs the up-scaling).

FIG. 10 illustrates an example of first HA part 71 in which the z-calculator does not belong to the first HA part 71 (and calculates the z factor based on at least one exponent field of the first FP value and the second FP value) and the rounding is applied on the non-rounded sum (by scaler and rounder 59 that followed enhanced range adder without rounder 58).

FIG. 11 illustrates an example of first HA part 71 in which the z-calculator does not belong to the first HA part 71 (and calculates the z factor based on at least one exponent field of the first FP value and the second FP value) and the rounding is applied on the first FP value (by first input scaler 72(1)) and on the second FP value (by second input scaler 72(2). In this example the enhanced range adder without rounder 58 is followed by rounder 59.

FIG. 12 illustrates an example of first HA part 71 in which the z-calculator does not belong to the first HA part 71 (and calculates the z factor based on an exponent field of the non-rounded sum outputted from the enhanced range adder without rounder 58), and the rounding is applied on the first FP value (by first input scaler 72(1)) and on the second FP value (by second input scaler 72(2). In this example the enhanced range adder without rounder 58 is followed by rounder 59.

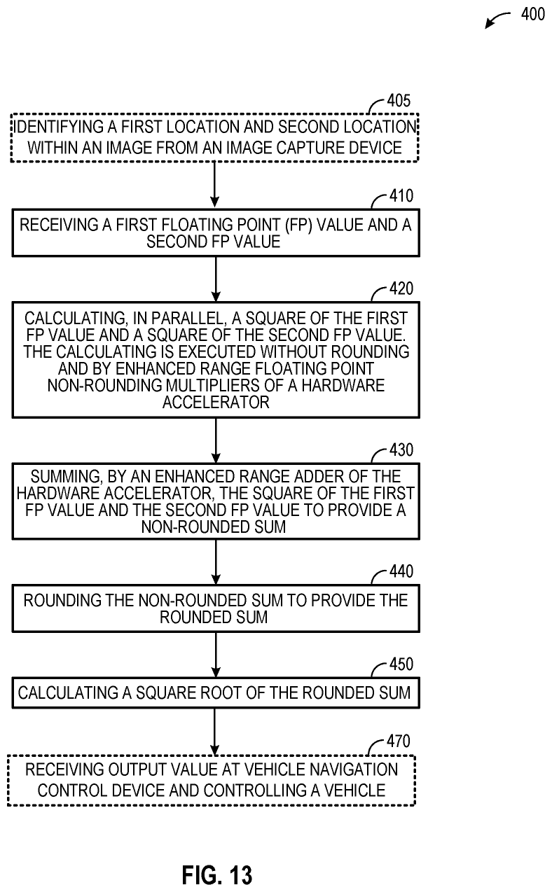

FIG. 13 illustrates an example of method 400 for floating-point calculation related to a sum of squares. Method 400 may include a one or more sequence of steps 405, 410, 420, 430, 440, 450, and 470. Step 405 may include identifying a first location and second location within an image from an image capture device, such as an image capture device for use within a vehicular ADAS or AV system. Step 410 may include receiving a first floating-point (FP) value and a second FP value. The first FP value and the second FP value may represent the first captured image location and the second captured image location, respectively.

Step 420 may include calculating, in parallel, a square of the first FP value and a square of the second FP value. The calculating is executed without requiring rounding and by enhanced range floating-point non-rounding multipliers of a hardware accelerator. Step 430 may include summing, by an enhanced range adder of the hardware accelerator, the square of the first FP value and the second FP value to provide a non-rounded sum. Step 430 may be executed by an enhanced range adder with a scaler. Step 440 may include rounding the non-rounded sum to provide the rounded sum. Step 440 may be executed by a rounder.

Step 440 may be followed by step 450 of calculating a square root of the rounded sum. In an example, the first FP value is a first difference between a value of a first coordinate of a first pixel and a value of a first coordinate of a second pixel, and the second value is a second difference between a value of a second coordinate of the first pixel and a value of a second coordinate of the second pixel. In this example, the rounded sum is a square of a distance between the first pixel and the second pixel, and the square root of the rounded sum generated in step 450 represents is the distance.

Step 470 may include receiving the square root of the rounded sum value at a vehicle navigation control device and controlling a vehicle based on the hardware accelerator calculated distance. When the square root of the rounded sum generated in step 450 represents the distance between two pixels, the distance between the first image location and the second image location may be used for navigation purposes, such as changing a vehicle direction, changing a vehicle speed, alerting a vehicle operator, or other vehicle operations.

Each one of the first FP value and the second FP value may consist of a sign bit, a first plurality (N1) of exponent bits, a second plurality (N2) of mantissa bits and an implicit mantissa most significant bit. Each one of the squares of the first FP value and the second FP value may consists of a sign bit, a third plurality (N3) of exponents bits, a fourth plurality (N4) of mantissa bits and an implicit mantissa most significant bit. N3 equals N1 plus one, and N4 equals one plus twice N2.

The non-rounded sum may consist of a sign bit, N3 exponents bits, N4 mantissa bits and an implicit mantissa most significant bit. It has been found that using N3 exponent bits is enough, especially when fulfilling a floating format that requires that the most significant bit of the mantissa equals one, which is represented by the implicit bit. If the summation results in a most significant bit of the mantissa equals one, then the mantissa field is right shifted by one bit to allow an insertion of a set value. Alternatively, the non-rounded sum may consist of a sign bit, (N3+1) exponents bits, N4 mantissa bits and an implicit mantissa most significant bit.

Some or all of the steps of method 400 may be executed in a pipelined manner. An iteration of method 400 may be triggered by a first command (for executing steps 420, 430 and 440) and by a second command (for executing step 450). The first command may be executed by a first cycle and wherein the second command may be executed during a second cycle.

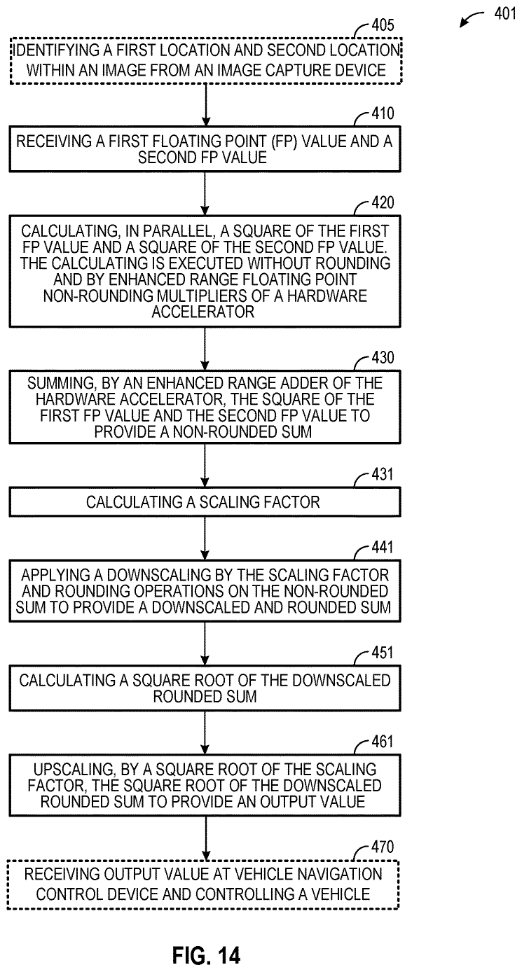

FIG. 14 illustrates an example of method 401 for floating-point calculation related to a square root. Method 401 may start by step 405, which may include identifying a first location and second location within an image from an image capture device, such as an image capture device for use within a vehicular ADAS or AV system. Step 405 may be followed by step 410 of receiving, by a hardware accelerator, a first floating-point (FP) value and a second FP value. The first FP value and the second FP value may represent the first captured image location and the second captured image location, respectively.

Step 410 may be followed by step 420 of calculating, in parallel, a square of the first FP value and a square of the second FP value. The calculating may be executed without requiring rounding and by enhanced range floating-point non-rounding multipliers of a hardware accelerator. Step 420 may be followed by step 430 of summing, by an enhanced range adder of the hardware accelerator, the square of the first FP value and the second FP value to provide a non-rounded sum.

Step 430 may be followed by step 431 of calculating a scaling factor. Step 431 may be followed by step 441. Alternatively, step 431 may follow step 410 and be followed by step 441. Step 441 may include applying a downscaling by the scaling factor and rounding operations on the non-rounded sum to provide a downscaled and rounded sum. Step 441 may be followed by step 451 of calculating a square root of the downscaled rounded sum. Step 451 may be followed by step 461 of upscaling, by a square root of the scaling factor, the square root of the downscaled rounded sum to provide an output value.

Step 461 may be followed by step 470 of receiving the square root of the rounded sum value at a vehicle navigation control device and controlling a vehicle based on the hardware accelerator calculated distance. When the square root of the rounded sum generated in step 451 represents the distance between two pixels, the distance between the first image location and the second image location may be used for navigation purposes, such as changing a vehicle direction, changing a vehicle speed, alerting a vehicle operator, or other vehicle operations.

The calculating, down-scaling, summing, and rounding may be triggered by a first command and the performing of the root square calculation and the up-scaling may be triggered by a second command. The calculating, down-scaling, summing, and rounding may be executed during a first cycle and the performing of the root square calculation and the up-scaling may be executed during a second cycle. Method 401 may be executed in a pipelined manner.

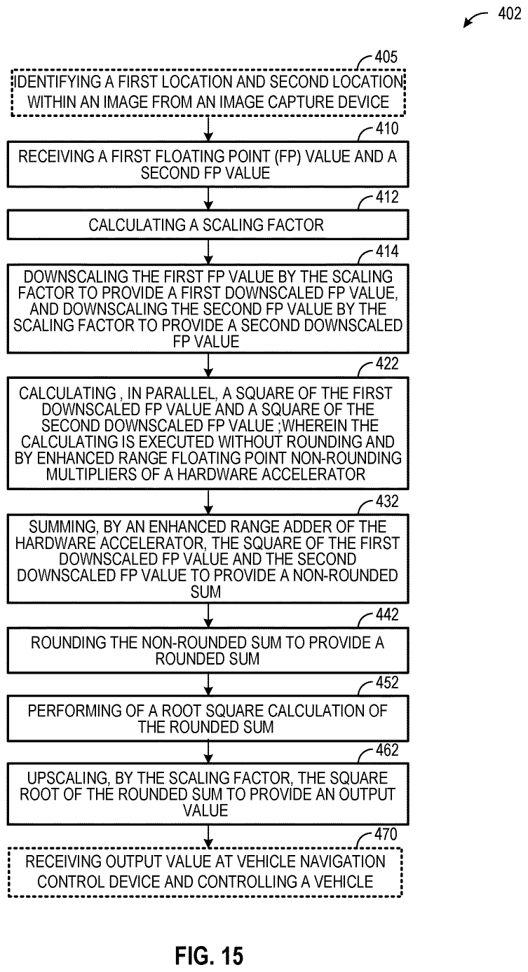

FIG. 15 illustrates an example of method 402 for floating-point calculation related to a square root. Method 402 may start by step 405, which may include identifying a first location and second location within an image from an image capture device, such as an image capture device for use within a vehicular ADAS or AV system. Step 405 may be followed by step 410 of receiving, by a hardware accelerator, a first floating-point (FP) value and a second FP value. The first FP value and the second FP value may represent the first captured image location and the second captured image location, respectively.

At step 412, method 402 may include calculating a scaling factor. Step 412 may include determining the scaling factor based on a size of at least one exponent field out of an exponent field of the first FP value and an exponent field of the second FP value. Step 412 may include determining the scaling factor to be equal two by a power of minus twice a maximum out of (a) an absolute value of an exponent field of the first FP, and (b) an absolute value of exponent field of the second FP value. Step 412 may include determining of the scaling factor based on a value of an exponent field of the non-rounded sum. Step 412 may include determining the scaling factor to equal two by a power of minus twice a fraction of an absolute value of an exponent field of the non-rounded sum. The fraction may be of any value, 5, 10, 20, 30, 33, 40, 55, 70, 85 percent or any other percent value. The determining of the scaling factor may be based on a size of at least one exponent field out of an exponent field of the first FP value and an exponent field of the second FP value. The scaling factor may equal two by a power of minus an absolute value of (a) an exponent field of the first FP, and (b) an exponent field of the second FP value.

At step 414, method 402 may include downscaling the first FP value by the scaling factor to provide a first downscaled FP value, and downscaling the second FP value by the scaling factor to provide a second downscaled FP value. At step 422, method 402 may include calculating, in parallel, a square of the first downscaled FP value and a square of the second downscaled FP value; wherein the calculating is executed without requiring rounding and by enhanced range floating-point non-rounding multipliers of a hardware accelerator. At step 432, method 402 may include summing, by an enhanced range adder of the hardware accelerator, the square of the first downscaled FP value and the second downscaled FP value to provide a non-rounded sum. At step 442, method 402 may include rounding the non-rounded sum to provide a rounded sum. At step 452, method 402 may include performing of a root square calculation of the rounded sum. At step 462, method 402 includes upscaling, by the scaling factor, the square root of the rounded sum to provide an output value.

Step 462 may be followed by step 470 of receiving the square root of the rounded sum value at a vehicle navigation control device and controlling a vehicle based on the hardware accelerator calculated distance. When the square root of the rounded sum generated in step 452 represents the distance between two pixels, the distance between the first image location and the second image location may be used for navigation purposes, such as changing a vehicle direction, changing a vehicle speed, alerting a vehicle operator, o*r other vehicle operations. The square root of the rounded sum generated in step 452 may be used in various other calculations, such as in determining a hypotenuse between any two points on a grid, which may be used to determine the proximity of two objects, the location or change in velocity of one object relative to another, or other spatial object features.

The calculating, down-scaling, summing, and rounding may be triggered by a first command and the performing of the root square calculation and the up-scaling are triggered by a second command. The calculating, down-scaling, summing, and rounding may be executed during a first cycle. The performing of the root square calculation and the up-scaling may be executed during a second cycle. Method 402 may be executed in a pipelined manner.

Each of the following non-limiting examples may stand on its own, or may be combined in various permutations or combinations with one or more of the other examples.

Example 1 is a method for hardware accelerator floating point calculations, the method comprising: receiving, at a floating point (FP) processing circuitry, a first FP value and a second FP value; determining a scaling factor based on the first FP value and the second FP value; calculating, in parallel, a first square of the first FP value and a second square of the second FP value, wherein the calculating is executed without requiring rounding and by enhanced range floating point non-rounding multipliers of the FP processing circuitry; summing, by an enhanced range adder of the FP processing circuitry, the first square of the first FP value and the second FP value to generate a non-rounded sum; applying a downscaling by the scaling factor and rounding operations on the non-rounded sum to generate a downscaled rounded sum; calculating a square root of the downscaled rounded sum; and upscaling, by a square root of the scaling factor, the square root of the downscaled rounded sum to generate a hardware accelerator output value.

In Example 2, the subject matter of Example 1 includes further subject matter where the FP processing circuitry includes an FP hardware accelerator.

In Example 3, the subject matter of Example 2 includes capturing a vehicle navigation image at an image capture device; identifying a first image location and a second image location within the vehicle navigation image; determining the first FP value based on the first image location; and determining the second FP value based on the second image location.

In Example 4, the subject matter of Example 3 includes receiving the hardware accelerator output value at a vehicle navigation control device, wherein the hardware accelerator output value represents a hardware accelerator calculated distance between the first image location and the second image location; and controlling a vehicle based on the hardware accelerator calculated distance.

In Example 5, the subject matter of Example 4 includes further subject matter where controlling the vehicle includes at least one of: changing a vehicle direction, changing a vehicle speed, or alerting a vehicle operator.

In Example 6, the subject matter of Examples 2-5 includes further subject matter where the scaling factor is determined based on a size of at least one exponent field out of an exponent field of the first FP value and an exponent field of the second FP value.

In Example 7, the subject matter of Examples 2-6 includes further subject matter where the scaling factor equals two by a power of minus twice a maximum out of (a) an absolute value of an exponent field of the first FP value, and (b) an absolute value of exponent field of the second FP value.

In Example 8, the subject matter of Examples 2-7 includes further subject matter where determining the scaling factor is based on a value of an exponent field of the non-rounded sum.

In Example 9, the subject matter of Examples 2-8 includes further subject matter where the scaling factor equals two by a power of minus twice a fraction of an absolute value of an exponent field of the non-rounded sum.

In Example 10, the subject matter of Examples 2-9 includes further subject matter where the calculating, down-scaling, summing, and rounding are triggered by a first command and the calculating of the square root, and the upscaling are triggered by a second command.

In Example 11, the subject matter of Examples 2-10 includes further subject matter where the calculating, down-scaling, summing, and rounding are executed during a first cycle and the calculating of the square root, and the upscaling are executed during a second cycle.

In Example 12, the subject matter of Examples 1-11 includes further subject matter where the method is executed in a pipelined manner.

Example 13 is a system for hardware accelerator floating point (FP) calculations, the system comprising: a memory to receive a first FP value and a second FP value; and an FP processing circuitry including: a scaling factor unit configured to determine a scaling factor based on the first FP value and the second FP value; enhanced range floating point non-rounding multipliers that are configured to calculate, in parallel and without requiring rounding, a first square of the first FP value and a second square of the second FP value; an enhanced range adder of the FP processing circuitry configured to add a first square of the first FP value and the second FP value to generate a non-rounded sum; a scaler and rounder configured to apply a downscaling by the scaling factor and rounding operations on the non-rounded sum to generate a downscaled rounded sum; a square root calculator configured to calculate a square root of the downscaled rounded sum; and an output scaler configured to upscale, by a square root of the scaling factor, the square root of the downscaled rounded sum to generate a hardware accelerator output value.

In Example 14, the subject matter of Example 13 includes further subject matter where: the memory includes an FP hardware accelerator memory; and the FP processing circuitry includes an FP hardware accelerator core.

In Example 15, the subject matter of Example 14 includes an image capture device to capture a vehicle navigation image; and an image processing device to: identify a first image location and a second image location within the vehicle navigation image; determine the first FP value based on the first image location; and determine the second FP value based on the second image location.

In Example 16, the subject matter of Example 15 includes a vehicle navigation control device to: receive the hardware accelerator output value, wherein the hardware accelerator output value represents a hardware accelerator calculated distance between the first image location and the second image location; and control a vehicle based on the hardware accelerator calculated distance.

In Example 17, the subject matter of Example 16 includes further subject matter where controlling the vehicle includes at least one of: changing a vehicle direction, changing a vehicle speed, or alerting a vehicle operator.

In Example 18, the subject matter of Examples 14-17 includes further subject matter where a determining of the scaling factor is based on a size of at least one exponent field out of an exponent field of the first FP value and an exponent field of the second FP value.

In Example 19, the subject matter of Examples 14-18 includes further subject matter where the scaling factor equals two by a power of minus twice a maximum out of (a) an absolute value of an exponent field of the first FP value, and (b) an absolute value of exponent field of the second FP value.

In Example 20, the subject matter of Examples 14-19 includes further subject matter where a determining of the scaling factor is based on a value of an exponent field of the non-rounded sum.

In Example 21, the subject matter of Example 20 includes further subject matter where the scaling factor equals two by a power of minus twice a fraction of an absolute value of an exponent field of the non-rounded sum.

In Example 22, the subject matter of Examples 20-21 includes further subject matter where a calculating, a down-scaling, a summing and a rounding are triggered by a first command and a calculating of the square root, and an upscaling are triggered by a second command.

In Example 23, the subject matter of Examples 20-22 includes further subject matter where a calculating, a down-scaling, a summing and a rounding are executed during a first cycle and a calculating of the square root, and an upscaling are executed during a second cycle.

In Example 24, the subject matter of Examples 20-23 includes further subject matter where the FP hardware accelerator core is configured to operate in a pipelined manner.

Example 25 is a method for hardware accelerator floating point calculations, the method comprising: receiving, at a floating point (FP) processing circuitry, a first FP value and a second FP value; determining a scaling factor based on the first FP value and the second FP value; downscaling the first FP value by the scaling factor to generate a first downscaled FP value; downscaling the second FP value by the scaling factor to generate a second downscaled FP value; calculating, in parallel, a first square of the first downscaled FP value and a second square of the second downscaled FP value, wherein the calculating is executed without requiring rounding and by enhanced range floating point non-rounding multipliers of the FP processing circuitry; summing, by an enhanced range adder of the FP processing circuitry, the first square and the second square to generate a non-rounded sum; rounding the non-rounded sum to generate a rounded sum; calculating a square root of the rounded sum; and upscaling, by the scaling factor, the square root of the rounded sum to generate a hardware accelerator output value.

In Example 26, the subject matter of Example 25 includes further subject matter where the FP processing circuitry includes an FP hardware accelerator.

In Example 27, the subject matter of Example 26 includes capturing a vehicle navigation image at an image capture device; identifying a first image location and a second image location within the vehicle navigation image; determining the first FP value based on the first image location; and determining the second FP value based on the second image location.

In Example 28, the subject matter of Example 27 includes receiving the hardware accelerator output value at a vehicle navigation control device, wherein the hardware accelerator output value represents a hardware accelerator calculated distance between the first image location and the second image location; and controlling a vehicle based on the hardware accelerator calculated distance.

In Example 29, the subject matter of Example 28 includes further subject matter where controlling the vehicle includes at least one of: changing a vehicle direction, changing a vehicle speed, or alerting a vehicle operator.

In Example 30, the subject matter of Examples 26-29 includes further subject matter where the determining of the scaling factor is based on a size of at least one exponent field out of an exponent field of the first FP value and an exponent field of the second FP value.

In Example 31, the subject matter of Examples 26-30 includes further subject matter where the scaling factor equals two by a power of minus an absolute value of (a) an exponent field of the first FP value, and (b) an exponent field of the second FP value.

In Example 32, the subject matter of Examples 26-31 includes further subject matter where the determining of the scaling factor is based on a size of an exponent field of the non-rounded sum.

In Example 33, the subject matter of Examples 26-32 includes further subject matter where the scaling factor equals two by a power of minus an absolute value of an exponent field of the non-rounded sum.

In Example 34, the subject matter of Examples 26-33 includes further subject matter where: the calculating, down-scaling, summing, and rounding are triggered by a first command; and the calculating of the square root and the upscaling are triggered by a second command.

In Example 35, the subject matter of Examples 26-34 includes further subject matter where: the calculating, down-scaling, summing, and rounding are executed during a first cycle; and the calculating of the square root and the upscaling are executed during a second cycle.

In Example 36, the subject matter of Examples 26-35 includes further subject matter where the method is executed in a pipelined manner.

Example 37 is a system for floating point (FP) hardware accelerator calculations, the system comprising: a memory to receive a first FP value and a second FP value; and an FP processing circuitry including: a scaling factor unit configured to determine a scaling factor based on the first FP value and the second FP value; a first input scaler configured to downscale the first FP value by the scaling factor to generate a first downscaled FP value; a second input scaler configured to downscale the second FP value by the scaling factor to generate a second downscaled FP value; enhanced range floating point non-rounding multipliers that are configured to calculate, in parallel and without requiring rounding, a square of the first downscaled FP value and a square of the second downscaled FP value; an enhanced range adder of the FP processing circuitry configured to add the square of the first FP value and the square of the second downscaled FP value to generate a non-rounded sum; a rounder configured to round the non-rounded sum to generate a rounded sum; a square root calculator configured to calculate a square root of the rounded sum; and an output scaler configured to upscale, by the scaling factor, the square root of the rounded sum to generate a hardware accelerator output value.

In Example 38, the subject matter of Example 37 includes further subject matter where: the memory includes an FP hardware accelerator memory; and the FP processing circuitry includes an FP hardware accelerator core.

In Example 39, the subject matter of Example 38 includes an image capture device to capture a vehicle navigation image; and an image processing device to: identify a first image location and a second image location within the vehicle navigation image; determine the first FP value based on the first image location; and determine the second FP value based on the second image location.

In Example 40, the subject matter of Example 39 includes a vehicle navigation control device to: receive the hardware accelerator output value, wherein the hardware accelerator output value represents a hardware accelerator calculated distance between the first image location and the second image location; and control a vehicle based on the hardware accelerator calculated distance.

In Example 41, the subject matter of Example 40 includes further subject matter where controlling the vehicle includes at least one of: changing a vehicle direction, changing a vehicle speed, or alerting a vehicle operator.

Example 42 is a method for floating point (FP) calculations, the method comprising: receiving a first FP value and a second FP value; calculating, in parallel, a square of the first FP value and a square of the second FP value; wherein the calculating is executed without rounding and by enhanced range floating point non-rounding multipliers of a processing circuitry; summing, by an enhanced range adder of the processing circuitry, the square of the first FP value and the second FP value to provide a non-rounded sum; and rounding the non-rounded sum to generate a rounded sum.

In Example 43, the subject matter of Example 42 includes further subject matter where the processing circuitry includes a hardware accelerator.

In Example 44, the subject matter of Example 43 includes performing a root square calculation of a square root of the rounded sum.

In Example 45, the subject matter of Example 44 includes further subject matter where: the first value includes a first difference between a value of a first coordinate of a first pixel and a value of a first coordinate of a second pixel; the second value includes a second difference between a value of a second coordinate of the first pixel and a value of a second coordinate of the second pixel; and the rounded sum includes a square of a distance between the first pixel and the second pixel.

In Example 46, the subject matter of Examples 44-45 includes further subject matter where the calculating, summing, and rounding are triggered by a first command and the performing of the root square calculation is triggered by a second command.

In Example 47, the subject matter of Examples 44-46 includes further subject matter where the calculating, summing, and rounding are executed during a first cycle and the performing of the root square calculation is executed during a second cycle.

In Example 48, the subject matter of Examples 43-47 includes further subject matter where each one of the first FP value and the second FP value consists of a sign bit, a first plurality (N1) of exponent bits, a second plurality (N2) of mantissa bits, and an implicit mantissa most significant bit.

In Example 49, the subject matter of Example 48 includes further subject matter where: each of the squares of the first FP value and the second FP value consists of a sign bit, a third plurality (N3) of exponents bits, a fourth plurality (N4) of mantissa bits and an implicit mantissa most significant bit; N3 equals N1 plus one; and N4 equals one plus twice N2.

In Example 50, the subject matter of Example 49 includes further subject matter where the non-rounded sum consists of a sign bit, N3 exponents bits, N4 mantissa bits and an implicit mantissa most significant bit.

In Example 51, the subject matter of Examples 49-50 includes further subject matter where the non-rounded sum consists of a sign bit, (N3+1) exponents bits, N4 mantissa bits, and an implicit mantissa most significant bit.

In Example 52, the subject matter of Examples 43-51 includes further subject matter where: the rounding is executed by a rounder; and the summing is executed by the enhanced range adder, wherein the enhanced range adder is without a rounder.

In Example 53, the subject matter of Examples 43-52 includes further subject matter where the method is executed in a pipelined manner.

Example 54 is a hardware accelerator device for floating point calculation related to a sum of squares, the hardware accelerator device comprising: one or more inputs for receiving a first floating point (FP) value and a second FP value; enhanced range floating point non-rounding multipliers of a processing circuitry that are configured to calculate, in parallel and without rounding, a square of the first FP value and a square of the second FP value; an enhanced range adder of the processing circuitry configured to add the square of the first FP value and the second FP value to provide a non-rounded sum; and a rounder configured to round the non-rounded sum to generate a rounded sum.

In Example 55, the subject matter of Example 54 includes further subject matter where the processing circuitry includes a hardware accelerator.

In Example 56, the subject matter of Example 55 includes a square root calculator configured to perform a root square calculation of a square root of the rounded sum.

In Example 57, the subject matter of Example 56 includes further subject matter where: the first value includes a first difference between a value of a first coordinate of a first pixel and a value of a first coordinate of a second pixel; the second value includes a second difference between a value of a second coordinate of the first pixel and a value of a second coordinate of the second pixel; and the rounded sum includes a square of a distance between the first pixel and the second pixel.

In Example 58, the subject matter of Examples 56-57 includes further subject matter where the hardware accelerator is configured to perform a calculating, a summing and a rounding based on a first command and is configured to execute a root square calculation based on a second command.

In Example 59, the subject matter of Examples 56-58 includes further subject matter where the hardware accelerator is configured to execute a calculating, a summing, and a rounding during a first cycle and perform the root square calculation during a second cycle.

In Example 60, the subject matter of Examples 55-59 includes further subject matter where each one of the first FP value and the second FP value consists of a sign bit, a first plurality (N1) of exponent bits, a second plurality (N2) of mantissa bits, and an implicit mantissa most significant bit.

In Example 61, the subject matter of Example 60 includes further subject matter where: each one of the squares of the first FP value and the second FP value consists of a sign bit, a third plurality (N3) of exponents bits, a fourth plurality (N4) of mantissa bits and an implicit mantissa most significant bit; N3 equals N1 plus one; and N4 equals one plus twice N2.

In Example 62, the subject matter of Example 61 includes further subject matter where the non-rounded sum consists of a sign bit, N3 exponents bits, N4 mantissa bits and an implicit mantissa most significant bit.

In Example 63, the subject matter of Examples 61-62 includes further subject matter where the non-rounded sum consists of a sign bit, (N3+1) exponents bits, N4 mantissa bits, and an implicit mantissa most significant bit. In Example 64, the subject matter of Examples 55-63 includes further subject matter where enhanced range adder is without a rounder.

In Example 65, the subject matter of Examples 55-64 includes further subject matter where the hardware accelerator is configured to operate in a pipelined manner.

Example 66 is at least one machine-readable medium including instructions that, when executed by processing circuitry, cause the processing circuitry to perform operations to implement of any of Examples 1-65.

Example 67 is an apparatus comprising means to implement of any of Examples 1-65.

Example 68 is a system to implement of any of Examples 1-65.

Example 69 is a method to implement of any of Examples 1-65.

Any reference to any of the terms “comprise,” “comprises,” “comprising” “including,” “may include” and “includes” may be applied to any of the terms “consists,” “consisting,” “and consisting essentially of.” For example, any of method describing steps may include more steps than those illustrated in the figure, only the steps illustrated in the figure or substantially only the steps illustrate in the figure. The same applies to components of a device, processor, or system and to instructions stored in any non-transitory computer readable storage medium.

The subject matter may also be implemented in a computer program for running on a computer system, at least including code portions for performing steps of a method according to the subject matter when run on a programmable apparatus, such as a computer system or enabling a programmable apparatus to perform functions of a device or system according to the subject matter. The computer program may cause the storage system to allocate disk drives to disk drive groups.

A computer program is a list of instructions such as a particular application program or an operating system. The computer program may for instance include one or more of: a subroutine, a function, a procedure, an object method, an object implementation, an executable application, an applet, a servlet, a source code, an object code, a shared library/dynamic load library or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as flash memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory, and a number of input/output (I/O) devices. When executing the computer program, the computer system processes information according to the computer program and produces resultant output information via I/O devices.

In the foregoing specification, the subject matter has been described with reference to specific examples of embodiments of the subject matter. It will, however, be evident that various modifications and changes may be made therein without departing from the broader spirit and scope of the subject matter as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the subject matter described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative, and that alternative embodiments may merge logic blocks or circuit elements, or may impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The illustrated examples may be implemented as circuitry located on a single integrated circuit or within a same device. Alternatively, the examples may be implemented as any number of separate integrated circuits or separate devices interconnected with each other in a suitable manner. The examples, or portions thereof, may implemented as soft or code representations of physical circuitry or of logical representations convertible into physical circuitry, such as in a hardware description language of any appropriate type.

The subject matter is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as “computer systems.”

Other modifications, variations and alternatives are also possible. The specifications and drawings are, accordingly, to be regarded in an illustrative rather than in a restrictive sense.

In the claims, any reference signs placed between parentheses shall not be construed as limiting the claim. The word “comprising” does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to subject matters containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the subject matter have been illustrated and described herein, many modifications, substitutions, changes, and equivalents will now occur to those of ordinary skill in the art. It is, therefore, to be understood that the appended claims are intended to cover all such modifications and changes as fall within the true spirit of the subject matter.

1. A method for hardware accelerator floating point calculations, the method comprising:
receiving, at a floating point (FP) processing circuitry, a first FP value and a second FP value;
determining a scaling factor based on the first FP value and the second FP value;
calculating, in parallel, a first square of the first FP value and a second square of the second FP value, wherein the calculating is executed without requiring rounding and by enhanced range floating point non-rounding multipliers of the FP processing circuitry;
summing, by an enhanced range adder of the FP processing circuitry, the first square of the first FP value and the second FP value to generate a non-rounded sum;
applying a downscaling by the scaling factor and rounding operations on the non-rounded sum to generate a downscaled rounded sum;
calculating a square root of the downscaled rounded sum; and
upscaling, by a square root of the scaling factor, the square root of the downscaled rounded sum to generate a hardware accelerator output value.

2. The method according to claim 1, wherein the FP processing circuitry includes an FP hardware accelerator.

3. The method according to claim 2, further including:
capturing a vehicle navigation image at an image capture device;
identifying a first image location and a second image location within the vehicle navigation image;
determining the first FP value based on the first image location; and
determining the second FP value based on the second image location.

4. The method according to claim 3, further including:
receiving the hardware accelerator output value at a vehicle navigation control device, wherein the hardware accelerator output value represents a hardware accelerator calculated distance between the first image location and the second image location; and
controlling a vehicle based on the hardware accelerator calculated distance.

5. The method according to claim 4, wherein controlling the vehicle includes at least one of: changing a vehicle direction, changing a vehicle speed, or alerting a vehicle operator.

6. The method according to claim 2, wherein the scaling factor is determined based on a size of at least one exponent field out of an exponent field of the first FP value and an exponent field of the second FP value.

7. The method according to claim 2, wherein the scaling factor equals two by a power of minus twice a maximum out of (a) an absolute value of an exponent field of the first FP value, and (b) an absolute value of exponent field of the second FP value.

8. The method according to claim 2, wherein determining the scaling factor is based on a value of an exponent field of the non-rounded sum.

9. (canceled)

10. The method according to claim 2, wherein the calculating, down-scaling, summing, and rounding are triggered by a first command and the calculating of the square root, and the upscaling are triggered by a second command.

11. The method according to claim 2, wherein the calculating, down-scaling, summing, and rounding are executed during a first cycle and the calculating of the square root, and the upscaling are executed during a second cycle.

12. The method according to claim 1, wherein the method is executed in a pipelined manner.

13. A system for hardware accelerator floating point (FP) calculations, the system comprising:
a memory to receive a first FP value and a second FP value; and
an FP processing circuitry including:
a scaling factor unit configured to determine a scaling factor based on the first FP value and the second FP value;
enhanced range floating point non-rounding multipliers that are configured to calculate, in parallel and without requiring rounding, a first square of the first FP value and a second square of the second FP value;
an enhanced range adder of the FP processing circuitry configured to add a first square of the first FP value and the second FP value to generate a non-rounded sum;
a scaler and rounder configured to apply a downscaling by the scaling factor and rounding operations on the non-rounded sum to generate a downscaled rounded sum;
a square root calculator configured to calculate a square root of the downscaled rounded sum; and
an output scaler configured to upscale, by a square root of the scaling factor, the square root of the downscaled rounded sum to generate a hardware accelerator output value.

14. The system according to claim 13, wherein:
the memory includes an FP hardware accelerator memory; and
the FP processing circuitry includes an FP hardware accelerator core.

15. The system according to claim 14, further including:
an image capture device to capture a vehicle navigation image; and
an image processing device to:
identify a first image location and a second image location within the vehicle navigation image;
determine the first FP value based on the first image location; and
determine the second FP value based on the second image location.

16. The system according to claim 15, further including a vehicle navigation control device to:
receive the hardware accelerator output value, wherein the hardware accelerator output value represents a hardware accelerator calculated distance between the first image location and the second image location; and
control a vehicle based on the hardware accelerator calculated distance.

17. The system according to claim 16, wherein controlling the vehicle includes at least one of: changing a vehicle direction, changing a vehicle speed, and alerting a vehicle operator.

18. The system according to claim 14, wherein a determining of the scaling factor is based on a size of at least one exponent field out of an exponent field of the first FP value and an exponent field of the second FP value.

19-24. (canceled)

25. A method for hardware accelerator floating point calculations, the method comprising:
receiving, at a floating point (FP) processing circuitry, a first FP value and a second FP value;
determining a scaling factor based on the first FP value and the second FP value;
downscaling the first FP value by the scaling factor to generate a first downscaled FP value;
downscaling the second FP value by the scaling factor to generate a second downscaled FP value;
calculating, in parallel, a first square of the first downscaled FP value and a second square of the second downscaled FP value, wherein the calculating is executed without requiring rounding and by enhanced range floating point non-rounding multipliers of the FP processing circuitry;
summing, by an enhanced range adder of the FP processing circuitry, the first square and the second square to generate a non-rounded sum;
rounding the non-rounded sum to generate a rounded sum;
calculating a square root of the rounded sum; and
upscaling, by the scaling factor, the square root of the rounded sum to generate a hardware accelerator output value.

26. The method according to claim 25, wherein the FP processing circuitry includes an FP hardware accelerator.

27. The method according to claim 26, further including:
capturing a vehicle navigation image at an image capture device;
identifying a first image location and a second image location within the vehicle navigation image;
determining the first FP value based on the first image location; and
determining the second FP value based on the second image location.

28-29. (canceled)

30. The method according to claim 26, wherein the determining of the scaling factor is based on a size of at least one exponent field out of an exponent field of the first FP value and an exponent field of the second FP value.

31-41. (canceled)
